(19) United States
(12) Patent Application Publication
(10) Pub. No.: US 2013/0340707 A1
(43) Pub. Date: Dec. 26, 2013

(54) ROTARY HEAT ENGINE

(71) Applicant: Victor Garcia Rodriguez, Logrono (ES)

(72) Inventor: Victor Garcia Rodriguez, Logrono (ES)

(21) Appl. No.: 13/977,489

(22) PCT Filed: Dec. 26, 2011
(86) PCT No.: PCT/ES2011/000374

§ 371 Date: Sep. 9, 2013

(30) Foreign Application Priority Data
Dec. 31, 2010 (ES) P201032021

(51) Int. Cl. F02B 53/04

(52) U.S. Cl. CPC F02B 53/04
USPC 123/241

(57) ABSTRACT

The invention relates to a rotary heat engine that consists of a hollow stator, the inner surface of which has a series of opposite deformations, and also has a cylindrical rotor on the perimeter of which are opposite recesses, defining at least two quadrants or sections that define expansion and expulsion chambers and other admission and compression chambers, wherein each section surface of the rotor has two grooves along which blades slide, by means of bearings that run through guides in the covers of the engine, such that it results in an engine that produces several expansions per revolution, thus managing to perform nearly all the work of the expansions in each cycle, improving the performance of alternate cylinder engines, including the famous Wankel rotary engine.

### OBJECT OF THE INVENTION

The proposed invention refers to a rotary engine formed by an axially hollow stator with a cylindrical interior with gradual and radial deformations. Inside the stator, there is a cylindrical rotor. On the rotor's circumference there are some opposite grooves.

The current invention is characterized by the special configuration and design of pieces and parts of the engine. Therefore, the engine can work as an explosion engine, using for instance gasoline, or as an internal combustion engine using gas-oil. Moreover, the engine's efficiency is increased in comparison to the known engines, because it takes the highest advantage of gas pressure in each work cycle.

Consequently, the current invention is inside the field of internal combustion engines, and particularly, inside rotary engines.

### BACKGROUND TO THE INVENTION

Alternative engines, known as petrol/gasoline engine and diesel engine, are internal combustion engines. The gas that results in combustion process pushes a piston, which it moves inside a cylinder and turns a crankshaft, to obtain a rotation movement.

Diesel engine is an engine of internal combustion, whose ignition is provided by the higher temperature that produces the air compression in the interior of cylinder.

The internal combustion engine is a kind of engine that uses the explosion of fuel, provoked by a spark, to expand the gas which pushes a piston.

Rotary engines search direct drive of the shaft without the alternations of a camshaft. The solutions tried so far, they do not achieve to beat the performance of classical cylinder engines with axial movement. That is why the efficiency of rotary engines has been lower than expected.

Therefore, the object of the current invention is to develop a rotary engine, specially designed according to the features showed in the first claim, with the purpose of obtaining the advantages of this kind of rotary engines, trying to beat the disadvantages found so far, improving the efficiency and being easy on its execution and simple on its working.

### DESCRIPTION OF THE INVENTION

The rotary engine object of the invention basically consists of a hollow stator, which in its internal circumference has gradual and radial deformations. These deformations arranged facing two by two, surrounding the circumference.

Inside the stator, there is a cylindrical rotor. On the rotor's perimeter there are also some facing grooves. The grooves of the rotor and the ones in the stator, as a whole, define the chambers.

The mentioned chambers are firstly, intake and compression chambers, and secondly, chambers of power and expulsion of the mixture.

In the beginning and the end of intake and compression chambers, the stator has some holes for the direct entry of the mixture of combustible and air, and also for the exit of the mixture exhaust from explosion expansion.

Whereas in correspondence with the beginning of the chamber of power/expansion and expulsion of mixture exhaust, there are on the stator little milled holes where could be placed some spark plugs in explosion engines. They can also be used as conducts for injecting the combustible if it is an internal combustion engine (diesel).

Besides, the rotor has radial grooves with variable depth. There are two grooves per each zone defined in the rotor. Each groove has one pallet inserted that slides through the groove. The pallets are slid due to a joint bearing in the end of the pallet. These bearings are guided by others curved grooves on both engine's heads. These grooves allow in a certain moment, that each pair of pallets are moved alternatively (one extended and the other one, that is the opposite) towards the stator's perimeter.

The pair of pallets inserted in each zone of the rotor, are moved toward the exterior, almost getting in contact with the stator, or on the contrary, in retracted position. A pallet moves toward the exterior or stays retracted, depending on the phase of the cycle: the one of intake or compression or the followings, ignition or exhaust.

In any case, it is important to remark about the position of pallets, that depends only and exclusively on grooves of both engine's heads.

This fact is due to the pallet's bearings are guided by these heads, and not by physical effects such as centrifugal force.

At a particular moment, pallets leave the zone which is defined as intake—compression phase to the zone of the ignition/expansion and exhaust phase. After this movement, pallets that before had moved toward the exterior, are retracted. Meanwhile, pallets that had been retracted due to the grooves in the engine's heads, now they stand out almost reaching contact (several μm) with the stator's interior face.

The rotor becomes lightened through the empty of some material in the parts which it is possible, with the aim of getting a reduction of its final weight.

In addition, with the goal of reaching the engine's cooling, this can be managed through the shaft. The shaft has an entry/admission of coolant and also an exit. Both are connected by internal pipes in the rotor. They form a closed circuit through the coolant flows, using for this purpose conventional two-passage rotary joints.

Likewise, the stator will have some milled holes for the fixing of engine's head with screws, or any similar method.

The whole engine is closed by two heads. These have a central hole with a bearing, to install the shaft. The joint shaft-bearing-head is enclosed by some little lubrication covers, which have a hole to allow the entry of lubricant.

The lubrication of pallet's bearings is achieved through some holes in the bottom of head's guides, which are connected with the lubrication tank. This simple system makes easy the lubrication of shaft's bearings, and also lubrication of pallets by the mist of oil produced by their own movement.

Therefore, due to the design of elements in this rotary engine, we have reached a simple engine as a whole. The rotor's spinning provokes: Firstly, the phase of compression of air or air-fuel mixture, after, the phase of ignition/expansion and at the same time, the final exhaust.

This engine can be used as a conventional spark-ignition (gas/petrol) and also as a diesel compression ignition technology. It can produce two or eight ignition/expansions per revolution, depending on the number of zones defined between rotor and stator. These configurations are equivalent to an engine of four or sixteen cylinders respectively. Moreover, this engine works in a more efficient way than conventional engines (Otto and Diesel cycles).

The expansions are produced in a simultaneous way in two diametrically-opposite zones. A perfect torque is achieved by this pair of opposite forces. This fact causes the balance and compensation of forces' system, so the shaft is not affected by unbalanced actions.

The main advantages of the engine object of the invention in comparison to conventional engines would be the following:
It can be developed an engine made of different materials such as ceramic, without wear, or low-density materials such as titanium . . . etc.
Low inertia, because the rotor can be made of low mass material.
It is perfect to work supercharged (increasing the ratio power/weight)
The engine forms a closed circuit. There is neither turbine nor open circuit.
A great relation between weight and power is achieved. This implies a high power in comparison to its low weight.
The engine can work with gasoline, gas, hydrogen, diesel, biodiesel etc.
It is very simple on its manufacture or mass production.
Eight (four-double) expansions are got each revolution.
It is an engine which does not need flywheels, crankshaft, or valves.
The whole phase of expansion is done with the maximum torque, due to the radius is maximum and also constant during the whole phase.
It hardly has vibrations.
Torque is always constant; not only when it works at high revolutions but also at low.
The engine has a low wear; due to the extremes of pallets do not get in contact with the interior of the stator.
It can work in every position: horizontal, vertical, bended . . .
It has an easy cooling, because the stator can be cooled through known and traditional systems, whereas the rotor is cooled through the shaft. This cooling is carried out through introduction and extraction of a fluid, by means of conventional two-passage rotary joints.
The lubrication not only of shaft's bearings, but also of pallets' bearings, can be done in a simple way.
It has a high thermodynamic and mechanic efficiency, increasing the obtained in conventional engines and Wankel rotary engine (Otto's cycle).
Intake and exhaust are done without head-loss in the in/out holes, because they have the same section than the one in previous chambers (effective surface of pallets). On the contrary, alternative engines are delimited by valves with reduced section.

### DESCRIPTION OF FIGURES

In order to complete the description of the engine, and with the aim of reaching a better comprehension of the features of the invention, it has been attached a set of drawings to the current descriptive report. These drawings show next figures:

FIG. 1 is a front view from the end of rotor. The fundamental structural characteristics of the rotor can be seen.

FIG. 2 shows a front view of rotor and stator connected, where the rotor has no pallets coupled.

FIG. 3 is a front view of rotor and stator, both coupled in a configuration of two expansions per revolution. Besides, all the construction features of both elements can be seen on section III-III, and also, the interaction and performance of all the engine's elements.

FIG. 4 is a front view of rotor and stator coupled in a configuration of eight expansions per revolution. Moreover, all the construction features of both elements are shown on section IV-IV, so as to the interaction and performance of the whole engine's elements.

FIG. 5 shows section V-V. It also shows all detail of the groove's bottom, having some holes through lubricant flows towards pallet's bearings.

FIG. 6, shows in detail two pallets, the bearings of the end of pallets and the shape of grooves.

On FIG. 7, the flow of the air or the mixture between combustible and air can be seen, from chamber in phase of intake/compression, to chamber in phase of expansion/exhaust.

FIG. 8, shows a frontal view of the whole engine, totally assembled.

FIG. 9, is an illustration of four-stroke “Otto” cycle diagram, in a conventional engine.

FIG. 10, is a comparative illustration of the cycle diagram of the engine object of the invention, using the same fuel as in the previous figure.

FIG. 11, is an illustration of the cycle diagram of a conventional “Diesel” engine.

FIG. 12, is a comparative illustration of the cycle diagram of the engine disclosed, using the same fuel as the previous figure.

### PREFERENTIAL EMBODIMENT OF THE INVENTION

Once seen previous figures and in accordance with the adopted numeration, they can be seen various examples of preferential carrying out of the invention. The invention includes parts and elements showed and described as it follows.

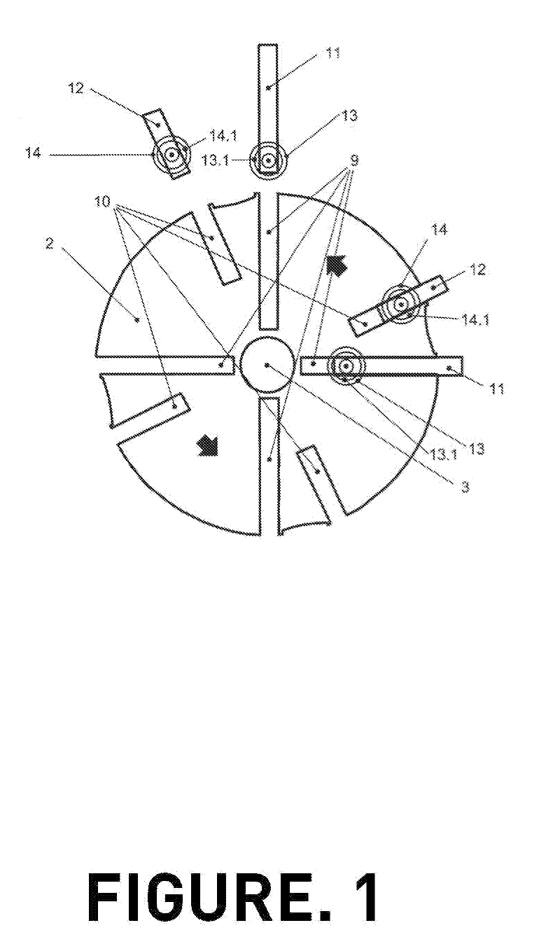

On FIG. 1, it can be observed a rotor (2) associated with a shaft (3). The mentioned rotor has a cylindrical configuration. On its perimeter has opposite deformations and also some diametrically opposite grooves (9) y (10), defining four zones.

These grooves have been drawn in a radial way, (steered towards the centre of rotor). Nevertheless, grooves can also adopt other convenient forms, for instance, situated parallel among them.

Each of four sectors in which the engine is defined (2) has one groove (9) of higher depth and another groove (10) of low depth.

This pair of grooves is used to guide some pallets (11) for intake/compression, and the others (12) for expansion/exhaust, respectively.

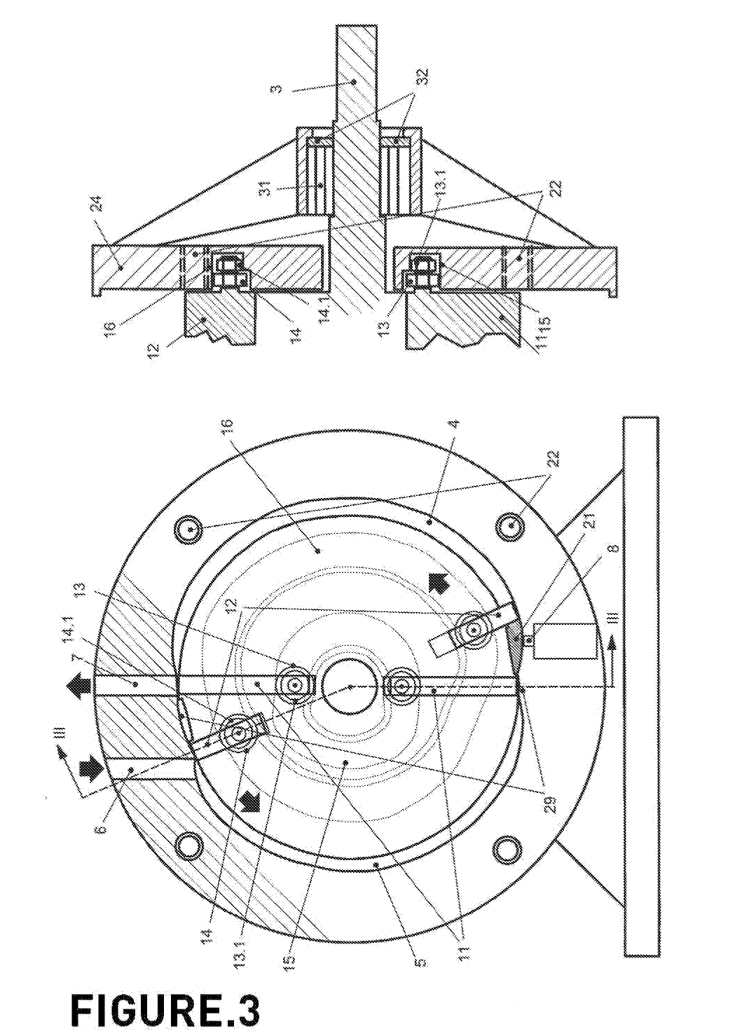

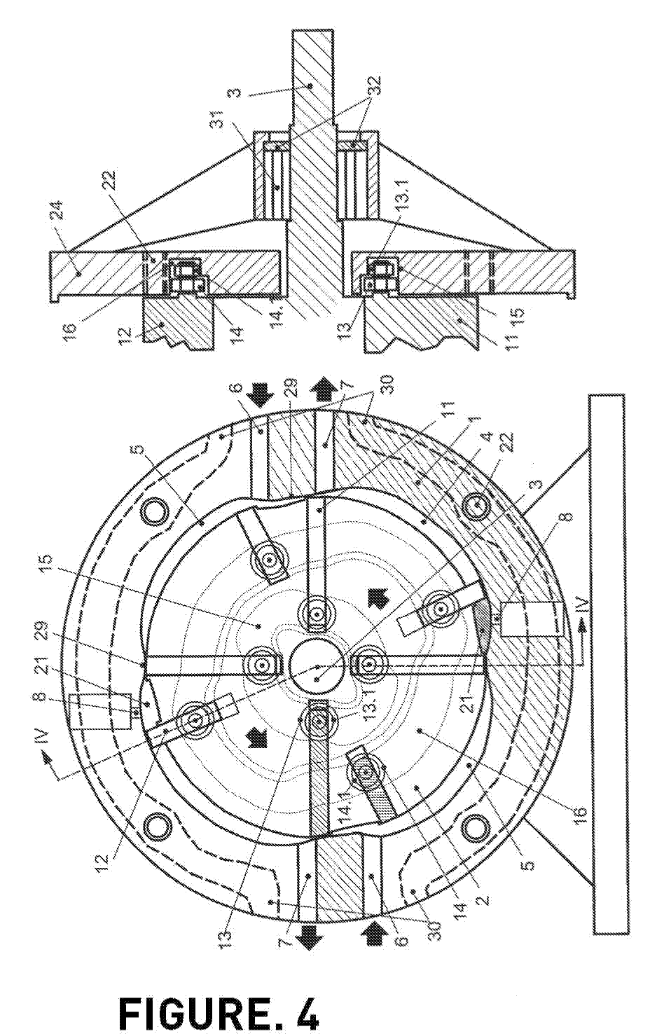

On FIGS. 3 and 4, the pallets (11) for intake/compression have in their closest extreme to the shaft, a pair of bearings (13 y 13.1), which protrude over the rotor, and roll along some curved grooves on both engine's heads (15) for the intake/compression pallets (11).

In the same way, the pallets (12) for expansion/exhaust, have in their closest extreme to the shaft, a pair of bearings (14 y 14.1), which protrude over the rotor, rolling along some curved grooves on both engine's heads (16) for the expansion/exhaust pallets (12).

Therefore, pallets' moving is conditioned by grooves' curved-geometry. On one side, intake/compression pallets (11) are guided by their bearings (13 and 13.1), which roll along the curved grooves (15). On the other side, expansion/exhaust pallets (12) are guided by their bearings (14 and 14.1), which roll along the curved grooves (16).

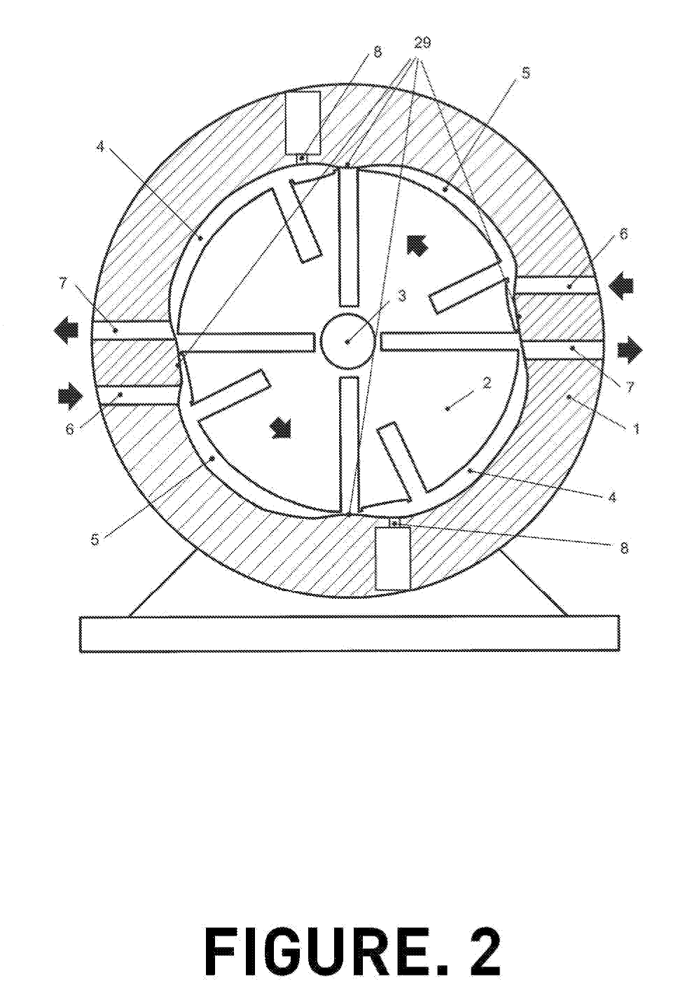

On FIG. 2, it is shown how the (1) cylindrical stator, has a hollow interior with some radial deformations which define four quadrants. These deformations are faced two-by-two (in couples). The deformations of stator's internal perimeter and the surface of rotor's external perimeter form several chambers (4 and 5), These chambers, (depend on the phases) are on one side expansion/exhaust chambers (4) and on the other side intake/compression chambers (5). The intake/compression phase is produced with a mixture of gas/air in case of engine's ignition, and just air in the rest of cases.

The expansion/exhaust chambers (4) have a volume which is as minimum the double of intake/compression chambers (5).

In the stator (1) there are some milled holes for the phase of intake (6) and some milled holes for the phase of exhaust (7), both in correspondence with intake (5) and exhaust (4) chambers. Moreover, in the stator there are defined some milled holes (8) accessible from the exterior of the stator (1), in which can be installed a system of ignition or an injector. The first will be for air/petrol mixture, such as spark plugs, in case of explosion engines, and the second will be for the internal combustion engine (diesel).

On FIG. 3, it can be observed the main construction features of a rotary engine based in the principles of the invention. It has two defined sectors in the rotor (2) and the stator (1), defining a “two expansions per revolution” engine. That is equivalent to a four strokes and four piston's engine.

It is important to remark in the drawing, how expansion/exhaust's pallets (12) are moved, due to the design of the curved deformations (16) that guide bearings (14 and 14.1). This fact makes the mentioned pallet, when it moves ahead, provokes the expansion in one of its faces, and in the other face allows the exhaust of gases produced in the previous expansion. These pallets (12) of expansion/exhaust when are moving ahead, provoke the difference between expansion and exhaust phases.

Equally, in intake/compression chambers are also intake/compression's pallets (11) which are diametrically moved towards the exterior of rotor, being retracted the expansion/exhaust's pallets (12).

On FIG. 3, it is shown how there have been planned some milled holes (22) in the stator, in order to close-head's fixing by the use of screws.

On FIG. 4, which is equivalent to the previous figure, it is remarkable that in the rotor (2), like in the stator (1), are defined four different sectors, so in each revolution are produced four pairs of simultaneous expansions. This means a total of eight expansions per revolution. Besides, due to diametrically opposite actions, the shaft supports balanced torques, which improves its durability.

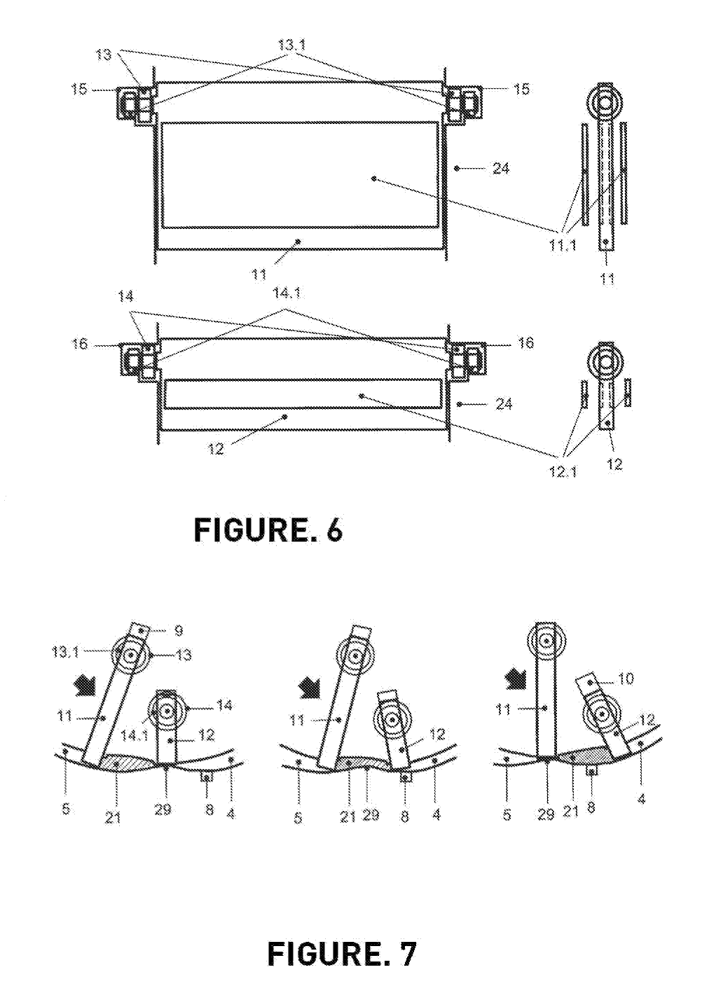

It is relevant to remark that pallet's (11 and 12) radial movement is exclusively conditioned, in every moment, by the geometry of curved grooves (15 and 16). Forces such as centrifugal force do not provoke any pallet's movement. This fact happens not only for intake/compression's pallets (11), but also for expansion/exhaust's pallets (12). There is also friction (well lubricated) between the rotor and the antifriction sheets (11.1 y 12.1) as it can be seen on FIG. 6.

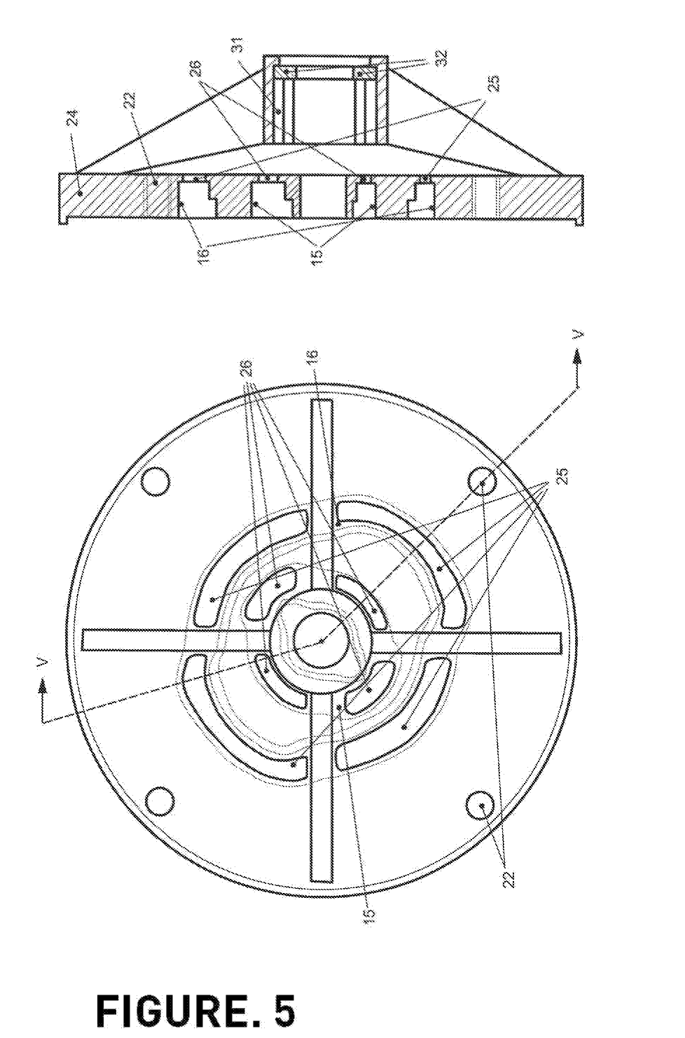

On FIG. 5, it can be observed one of the heads (24) which closes one side of the engine, and how the curved grooves are made in it (15 and 16). Bearings (13 and 13.1) and (14 and 14.1) roll over these grooves. These grooves/guides (15 and 16) are connected with the opposite face of the head (24), through discontinuous milled holes (25 and 26) with the aim of allowing the lubricant flows.

On FIG. 6, it can be seen, in detail, a possible way of groove/guide's formation (15). The groove is narrower in its bottom than in its connection with the exterior, defining a little step in cross section. The same geometrical characteristics in its cross section are remarkable for curved grooves (16).

The grooves (15) have a narrower internal area/zone and a wider external area/zone, and in each of them, it is inserted the first bearing (13) and the second one (13.1) respectively. That implies while the bearing (13) gets in contact with the higher groove' surface, the bearing (13.1) gets in contact with the lower groove' surface. These points of contact limit the radial movement, in one direction or the opposite of intake/compression's pallets (11).

In grooves (16) is the same to (15), but in this case, bearings (14 and 14.1) belong to expansion/exhaust's pallets (12).

An alternative making of groove's section (15 and 16) could be carried out through a uniform section without any step, where both inserted bearings could have the same external diameter. Whereas internal diameter is different, thanks to an eccentric configuration.

Due to grooves' geometry (15 and 16) and the existence of bearings, pallets' movement is fully achieved.

On FIG. 7, it is shown another important aspect of the invention: The pallets and grooves' design; This design involves that in pallets' radial movement, these can approach to the interior of the stator, both very closed, but without getting in touch with them. That avoids the wear of pallets and the stator. On this FIG. 7, it can be observed on the three illustrations, how it is produced the transfer of the mixture (21) from the intake/compression chamber to the expansion/exhaust chamber, It can be also seen, how even in the point (29) in which the rotor is closest to the stator, they do not contact, allowing the transfer of the mixture without losing pressure.

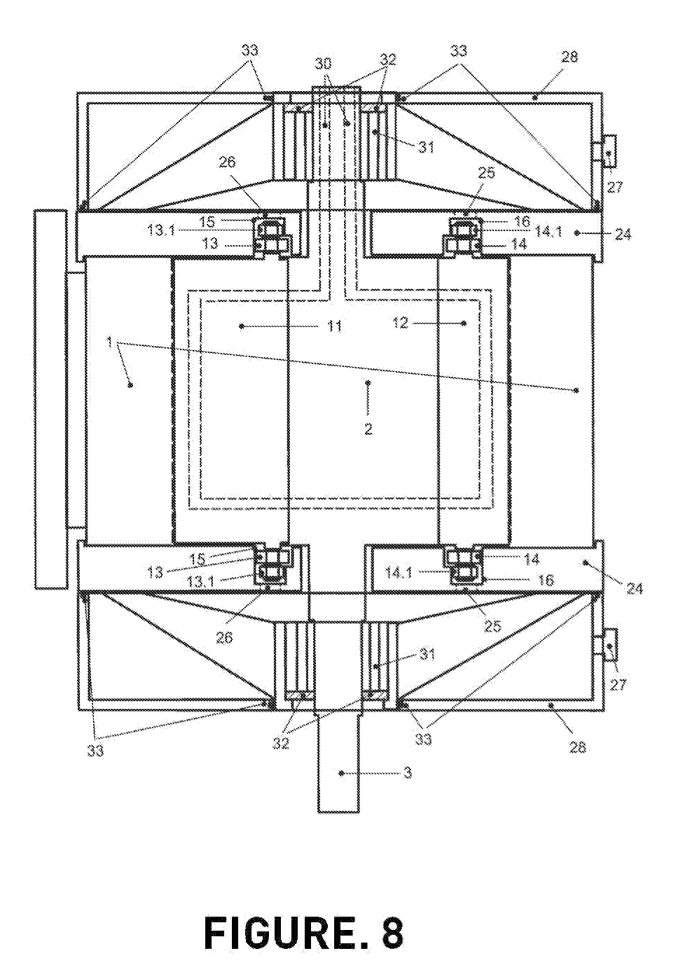

On FIG. 8, it can be observed the whole engine ensemble, where the engine's heads (24) are placed in both sides of the rotor and stator. On figure, it can also be seen the grooves (15 and 16) through bearings (13 and 13.1) of pallets of intake/compression (11) and bearings (14 and 14.1) of expansion/exhaust's pallets (12) roll.

It is important to remark that over the engine's heads (24) are other heads (28) (they can be transparent), to keep the lubricant with its screw-on caps (27).

Every bearing (13, 13.1,14 and 14.1), and at the same time every pallet (11 and 12) and the rotor (2) will be perfectly lubricated, through the milled holes (25 and 26) so as the main shaft's bearing (31). There will be no loss of lubricant in shaft's bearing (31) because it has a shaft seal (32).

Covers (28) are hermetically sealed with the heads (24) by gasket/O-ring seals.

With the described performance, the engine's ensemble produces eight expansions per revolution. This is equivalent to a performance of a conventional engine of sixteen cylinders and four strokes. This is achieved due to the total exploitation of exhausts in each cycle, getting a higher efficiency than in piston's engines.

In addition, with the aim of getting the engine's cooling, this can be done through its own shaft (3), which has an entry/admission of coolant and also an exit (30). Both are connected by some internal pipes/conducts in the rotor, forming a close circuit through the coolant flows. This process is achieved using two-passage rotary joints.

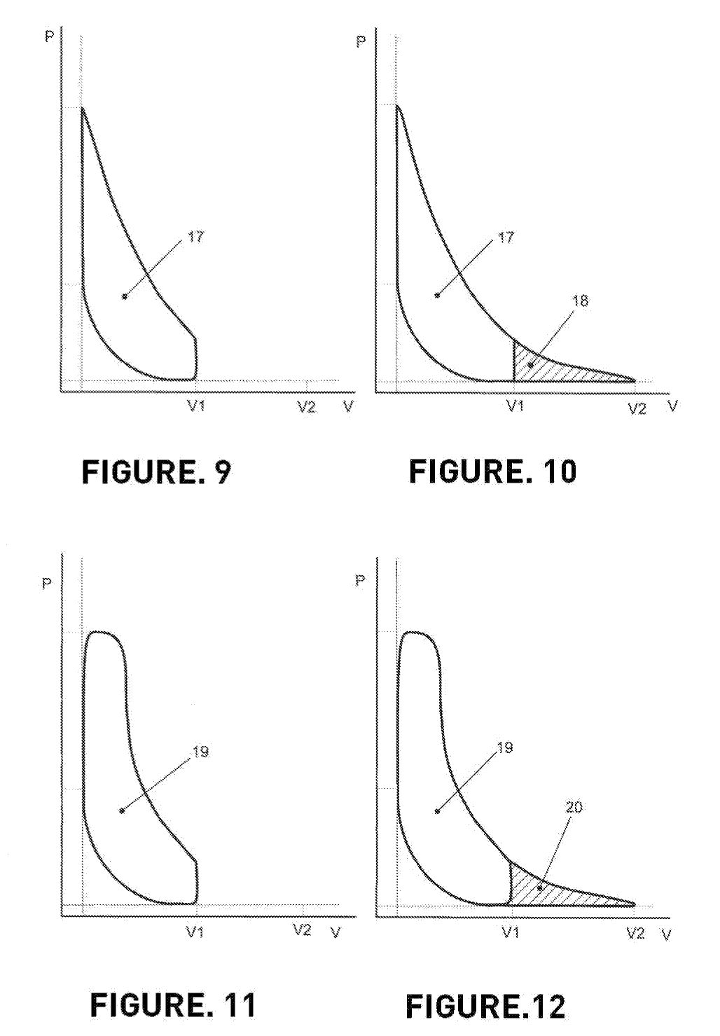

On FIG. 9 it is drawn a cycle diagram of a conventional “OTTO” engine, which defines a work/energy area (17); it is illustrated on FIG. 10 the cycle diagram of the engine object of invention with the same fuel. It can be clearly seen that its work/energy area is increased in an area (18), being V₂=2V₁ (Atkinson Cycle).

On FIG. 11, it is shown the cycle diagram of a conventional engine “DIESEL”, which defines a work/energy area (19); it is illustrated on FIG. 12 the cycle diagram of the engine object of invention. It is relevant to see that its work/energy area (19) of conventional performance, is increased in an area (20), being also V₂=2V₁ (Atkinson Cycle).

Once described the nature of the current invention, and also its working, it is not necessary to make a more extensive explanation. Any skilled in technical subjects could understand its advantages and future sales.

It can be developed in many ways; even those which differ in any detail from the one described as the example. The invention will protect all these different details of the example, whenever there is no alteration, change or modification on its essential principle.

1. Internal combustion rotary engine, formed by a rotor (2), a shaft (3) joined to the rotor, an empty inside stator (1) and two engine heads (24) to close both engine's sides, characterized in that:
The mentioned rotor has a cylindrical configuration. On its perimeter has opposite deformations and also some diametrically opposite grooves (9) y (10), defining several zones. In each rotor's zone (2) there are two grooves. One of these (9) is deeper than the other one (10). In both grooves there are intake/compression' pallets (11) and expansion/exhaust' pallets (12) respectively. The pallets slide along the grooves (9 and 10) thanks to some joined bearings, which roll along other curved grooves (15 and 16).
The cylindrical stator (1) is empty inside. Its internal perimeter has several deformations. These deformations are opposite, surrounding its circumference, and they define some zones.
The whole of rotor and stator's deformations (1) form some chambers. On one side, there is the intake/compression (5) chamber, and on the other side, there is the expansion/exhaust (4) chamber. There are also diametrically opposite some milled holes, to allow entry (6) and exhaust (7) respectively.

2. According to claim number 1, the rotary engine distinguishes itself because the movement of intake/compression' pallets (11) is managed by two bearings (13 and 13.1). Likewise, expansion/exhaust' pallets (12) are joined to two bearings (14 and 14.1). The group of bearings roll along some curved grooves (15 and 16), milled in both engine's heads (24).

3. According to claim number 3, the rotary engine distinguishes itself because the curved grooves (15 and 16) have an internal area/zone narrower, and an external area/zone wider, and in each of them, it is inserted the first bearing (13 and 14) and the second (13,1 and 14.1) respectively. That implies while the first bearing (13 and 14) gets in contact with the higher groove' surface, the second bearing gets in contact with the lower groove' surface.

4. According to claim number 1, the rotary engine distinguishes itself because of groove's section (15 and 16), that have a uniform section, where both inserted bearings have the same external diameter. Whereas internal diameter is different, thanks to an eccentric configuration.

5. According to claim number 1, the rotary engine distinguishes itself because expansion/exhaust' chambers (4) have at least, double volume than intake/compression chambers (5).

6. According to claim number 1, the rotary engine distinguishes itself because in the stator there are defined some milled holes (8) accessible from the exterior of the stator (1).

7. According to claim number 1, the rotary engine distinguishes itself because the rotor's cooling system is achieved through its shaft. The shaft has an entry/admission of coolant and also an exit. Both are connected by internal pipes in the rotor. They form a closed circuit through the coolant flows, using for this purpose, conventional two-passage rotary joints. The stator is cooled by means of standard systems in conventional engines.

8. According to claim number 1, the rotary engine distinguishes itself because over the engine's heads (24) are other heads (28), which cover the shaft's bearing (31), and define some chambers to keep the lubricant. The chambers are filled with this lubricant through some holes, which are closed with screw-on caps (27).

9. According to claim number 9, the rotary engine distinguishes itself because the curved grooves (15 and 16) allow lubricant flow through discontinuous milled holes (25 and 26) with the aim of getting the pallet's lubrication.

10. According to claim number 1, the rotary engine distinguishes itself because antifriction sheets (11.1 y 12.1) are installed on the surface of intake/compression' pallets (11) and expansion/exhaust' pallets (12).

11. According to any claim exposed before, the rotary engine distinguishes itself because between rotor and stator are defined two zones, which implies it is an engine of two expansions per revolution.

12. According to any of the claims exposed before, the rotary engine distinguishes itself because between rotor and stator there are four zones defined, which implies it is an engine of eight expansions per revolution.
